(19) United States
(12) Patent Application Publication
(10) Pub. No.: US 2007/0162258 A1
(43) Pub. Date: Jul. 12, 2007

(54) Remote customer interactive motor design system and method

(75) Inventors: Ryan Lin, Santa Clara, CA (US); Ted Lin, Santa Clara, CA (US)

Correspondence Address: CANADY & LORTZ, 2540 HUNTINGTON DRIVE, SUITE 205, SAN MARINO, CA, 91108, US

(73) Assignee: Lin Engineering Inc., Santa Clara, CA (US)

(21) Appl. No.: 11/327,524

(22) Filed: Jan. 6, 2006

(51) Int. Cl. G06F 19/00

(52) U.S. Cl. 702/186; 702/127; 702/182

(57) ABSTRACT

Systems and methods are disclosed for the remote design of an electric motor (e.g. an AC or DC motor) by a customer through an interactive Web-based process. A typical system includes a Web server capable of delivering an interactive web page to a remote system. The web page includes one or more input fields allowing a user to specify motion performance requirement values applied to a design algorithm. The user may specify only some of the possible performance values. The design algorithm generates electric motor design parameters which will achieve the desired performance values. The algorithm also performs a parametric search through an existing parts database for at least some existing components which can be used in the electric motor design. The electric motor performance data is presented as an output to the user.

### BACKGROUND OF THE INVENTION

1. Field of the Invention

The present invention relates to systems and methods for remote automated electric motor design system. Particularly, this invention relates to systems and methods for web-based remote customer interactive electric motor design.

2. Description of the Related Art

In a conventional design process, new designs for electric motors are generated through a calculation of system loads, inertias, and torques. For example, this may be performed primarily through a spreadsheet calculation or by hand analysis. The process can take a significant amount of time when designing a new electric motor. Further design optimizations are even more calculation intensive, taking longer to analyze and compute. Accordingly, few companies in the industry provide the capability of such design optimization.

Prior art software has been developed to aid in the design of various types of electric motors. However, such design software is typically installed on a computer system and operated by a skilled user over multiple sessions to develop a finished design.

For example, www.softbitonline.com provides AC electric motor design software. The window based software gives numerical, pictorial and graphical outputs to understand various design data values. The software allows a user to change any output design data value as per user requirements and get the changed values instantly without affecting the final design and performance of the motor. The software is developed for engineers to improve productivity with relatively easy to learn features and full documentation that includes information on machine theory and design. Although motor design with the software is faster, the software does not do the engineer's job. It is simply a specialized calculating tool to assist the design engineers with initial sizing and preliminary design of a motor by providing a simple intuitive interface and quick simulation.

Another software tool, speed motor design simulation software, is provided by www.speedcad.com. This software aids design and performance calculations for certain types of electric machines including induction motors, brushless permanent magnet motors, permanent magnet DC motor and switched reluctance motors. Motor or generator design with the software is interactive, increasing productivity. This software is also backed with full documentation including extensive information on motor theory and design. However, here also the software does not do the engineer's job. Rather, the software is simply a specialized calculating tool to assist the design engineer with sizing, performance calculations and initial optimization.

However, such software is designed to be operated by a single user on a local computer. In addition, while the software may afford a degree of simplification and easy-to-operate functions, they not allow a user to merely specify performance characteristics of a desired electric motor and provide a complete design. In addition, some customers may restrict the downloading and use of unapproved software by engineers and designers. This provides another obstacle for the design process. In addition, such software tools are conceived for the development of relatively unique parts for each motor design. Although such an approach may allow a wider theoretical range of designs, it further delays the production of a new motor.

One known technique to alleviate this type of delay is to employ a parametric search of the existing motor designs. Parametric searches are static and search only among motors that are already in the system. However, typically in the prior art, only complete motors existing are searched through in the parametric search. Values for a combination performance parameters, e.g. torque, resistance, voltage, are entered into the search engine and the search algorithm identifies the closest match. However, conventional parametric searches do not perform an optimized selection or optimize the motor design. In other words, in the prior art, the process ends when the closest match is determined. But in many cases the closest match may be a motor with performance measurements exceeding (or deficient) the target (e.g. torque or power) by fifty percent or more. This can result in selected motors being under- or over-designed for a particular application.

However, conventional parametric searches only provide a search for motors available in stock or a standard motor parameter from a motor company. The conventional parametric search does not allow for optimization of a hypothetical motor design that does not yet exist. Furthermore, some relatively elaborate design systems have been developed.

U.S. Pat. No. 5,822,206, issued Oct. 13, 1998 to Sebastian et al., discloses a computer-based engineering design system to design a part, a tool to make the part, and the process to make the part. The design system has a processor and a memory. The memory stores feature templates, each feature template being a representation of a primitive object having a form and a function. Each feature template is indexed by the function of the primitive object and includes a representation of a primitive geometric entity having the form of the primitive object. Each feature template can include information relating to a tool to make the primitive object and a process to make the primitive object. The design system also includes an input device for receiving a request to design the part. This request includes one or more predetermined functions that the part performs. A core design module, executable by the processor, designs the part, the tool to make the part and process to make the part by accessing the plurality of feature templates in the memory to locate one or more primitive objects that perform the one or more predetermined functions.

While U.S. Pat. No. 5,822,206 employs feature templates and corresponding primitive objects, it does not enable development of a new design from only performance requirements provided by a customer. In addition, this system still requires direct control by a human

Some networked or web-based design software tools have also been developed. In this prior art, the focus has generally been to facilitate an efficient design or project process among users at different locations.

U.S. Pat. No. 6,397,117, issued May 28, 2002 to Burrows et al., discloses a distributed computer aided design (CAD) system including a CAD server station and one or more CAD client stations remote from the server station but connectable thereto via a communications medium such as an intranet or the internet. The CAD server station includes a CAD tool for performing CAD tasks and a communications interface. The CAD client stations include display and data entry facilities for displaying a design parameter entry document to a user and for accepting design parameters entered by the user, as well as a communications interface for transmitting entered design parameters via the communications medium to the server station. The CAD tool at the server station is configured to receive the design parameters from the client station, to perform CAD tasks based on the design parameters and to return processed design data to the server station via the communications medium. The client station can include a workstation with a web browser capability. The server station can be configured to respond to a request from a client station to supply a design parameter input form. Integrated circuit design can be performed by providing circuit design executables and circuit design libraries (e.g. for memory cells) at the CAD tool. The CAD tool can also provide simulation tools.

U.S. Patent No. Application No. 2004/0039771; published Feb. 26, 2004 by Steinel et al., discloses an invention related to a method, a computer program and a system for carrying out a project from a plurality of differently located electronic data processing (EDP) devices, which are connected via a data network with a main server serving the central data loading for the purpose of data exchange and whereby, during individual working time intervals, respectively one other from the plurality of EDP devices for carrying out the project is at least partially activated. Proceeding from this prior art, the aim of the invention is to develop a known method, computer program and system of the stated kind in such a way that employees at other sites, lying at a distance from the main server, are permitted full cooperation in a project. This aim is solved in accordance with the invention by the fact that the data network is designed in a cross-locational manner, and that the individual EDP devices are located distributed at least partially in a cross-locational manner.

U.S. Patent No. Application No. 2005/0080502, published Apr. 14, 2005 by Chernyak et al., discloses a tool for computer-aided design, computer-aided manufacturing forming a Project Management System, comprising a Component Database; a Component Data Management System; a Design and Manufacturing System; an Assembly Drawing Generator; a Bill of Materials Generator; and, a Project Database. The Project Manager tracks the process and actions, recording and supervising version and change order compliance and task completion, from the start through verification of a production-ready finished version. Each project uses a master workbench. On it design specifications are entered for each subassembly element and connector. Then the user consults the Component Database using a Search and Cross Reference engine for components meeting those design specifications, until a constraint-satisfying design is completed. The tool generates a Bill of Materials, Assembly Drawings, and process records for the project in process.

U.S. Pat. No. 6,910,631, issued Jun. 28, 2005 to Knowles et al., discloses an Internet enabled method and system for designing, and manufacturing laser scanners of modular design and construction using globally based information networks, such as the Internet, supporting the World Wide Web (www).

Notably, prior art systems and methods lack the ability for a remote user to receive performance estimates for a proposed stepper motor design, where the proposed stepper motor design is automatically generated from desired performance requirements from the user.

In view of the foregoing, there is a need in the art for systems and methods for generating unique electric motor designs efficiently though direct customer interaction. In addition, there is a need for such systems and methods to generate unique electric motor designs, providing calculated performance estimates of the unique electric motor design and coupled with ordering the same electric motors. Further, there is a need for such electric motor designs to be derived from performance requirements provided by the customer. Also, there is a need for the design processes for such customer-interactive systems and methods to remain secured from the user while they are being used. These and other needs are met by the present invention as detailed hereafter.

### SUMMARY OF THE INVENTION

The present invention discloses systems and methods for the remote design of an electric motor (e.g. AC Brake motors, AC Hysteresis Motors, AC Induction Gearmotors, AC Induction motors, AC motors, AC Permanent Magnet Motors, AC Servomotors, Brush motors, Brushless DC Gearmotors, Brushless DC motors, Brushless Motors, DC Brush Gearmotors, DC Brush Motors, DC Micro Motors, DC motors, Fan Motors, Linear Brush DC motors, Linear Brushless DC motors, Linear Motors, Linear Servo Motors, Linear Stepper Motors, Servo Motors, Spindle Motors, Stepper Gearmotors, Stepper Motors, Synchronous Motors, Variable Switched Reluctance Motors, Vibration Motors) by a customer through an interactive Web-based process. A typical system includes a Web server capable of delivering an interactive web page to a remote system. The web page includes one or more input fields allowing a user to specify motion performance requirement values applied to a design algorithm. The user may specify only some of the possible performance values. The design algorithm generates electric motor design parameters which will achieve the desired motion performance values. The algorithm also performs a parametric search through an existing parts database for at least some existing components which can be used in the electric motor design. The electric motor performance data of the final design is presented as an output to the user. The user may also enter contact and/or billing information (e.g. through an e-commerce server) to place an order directly for the generated design. In addition, the system may operate such that the user is only able to review the input and output of the process and not the underlying design algorithm. The design may then be produced as a prototype (or final product) at a manufacturing facility and delivered to the customer. This facility may be anywhere in the world and need not reside at the same location as the design system.

A typical embodiment of the invention comprises a system for electric motor design comprising a communication device for communicating a data entry request for one or more performance requirements of a desired electric motor to a remote user and a computing device for receiving the one or more performance requirements and generating one or more electric motor designs satisfying the one or more performance requirements. Calculated performance information for each of the one or more electric motor designs are communicated back to the remote user by the computing device for evaluation by the remote user. The one or more performance requirements may include a torque, a resistance, motor voltage, motor current, a supply voltage, a supply current, and/or a motion profile. The computing device may first perform a power calculation based on the one or more performance requirements from the remote user to check for power availability.

The communication device typically comprises an Internet-connected computer network device and the data entry request comprises one or more interactive web pages. The Internet-connected computer network device may include a web server coupled to a database server. The web server prepares the one or more interactive web pages and receives the one or more performance requirements. The database server provides one or more existing component models to be employed in the one or more electric motor designs available for selection by an electric motor design algorithm in a parametric search.

The one or more existing component models may comprise one or more electric motor winding designs. In addition, the electric motor design algorithm may comprise a secure design algorithm blocked from review by the remote user.

Further embodiments may include an e-commerce server coupled to the web server. The e-commerce server may receive the one or more electric motor designs and generate a price quote for the one or more electric motor designs.

Still further embodiments may also include an e-mail server coupled to the e-commerce server. An electronic purchase order may be received by the e-commerce server in response to the user accepting the price quote and the e-mail server then sends a confirmation e-mail message of the electronic purchase order. The price quote may also include an identification code for the user to place an order by facsimile or telephone.

Similarly, a typical method embodiment for designing a motor, comprises communicating a data entry request for one or more performance requirements of a desired electric motor to a remote user, receiving the one or more performance requirements, generating one or more electric motor designs satisfying the one or more performance requirements, calculating performance information for each of the one or more electric motor designs, and communicating the calculated performance information for each of the one or more electric motor designs back to the remote user by the computing device for evaluation by the remote user.

The method may further include performing a power calculation based on the one or more performance requirements from the remote user to check for power availability before generating the one or more electric motor designs.

The data entry request may comprise one or more interactive web pages from an Internet-connected computer network device. The Internet-connected computer network device may comprise a web server coupled to a database server and the method further comprises preparing the one or more interactive web pages with the web server, receiving the one or more performance requirements with the web server, and providing one or more existing component models with the database server for selection by an electric motor design algorithm in a parametric search to be employed in the one or more electric motor designs.

The method may further comprise receiving the one or more electric motor designs from the web server with an e-commerce server and generating a price quote for the one or more electric motor designs with the e-commerce server. The method may also comprise receiving an electronic purchase order with the e-commerce server in response to the user accepting the price quote and sending a confirmation e-mail message of the electronic purchase order with the e-mail server.

### BRIEF DESCRIPTION OF THE DRAWINGS

Referring now to the drawings in which like reference numbers represent corresponding parts throughout:

FIG. 1 depicts a functional block diagram of an exemplary embodiment of a remote customer interactive electric motor design system;

FIG. 2A is a block diagram of an exemplary computer system that can be used to perform the operations of the remote customer interactive electric motor design system;

FIG. 2B is a block diagram of an exemplary networked computer system that can be used to perform the operations of the remote customer interactive electric motor design system;

FIG. 3 is a flowchart of operations of an example remote customer interactive electric motor design process;

FIG. 4 illustrates an example graph 400 of a performance estimate of the proposed motor design; and

FIG. 5 is a flowchart of an exemplary method of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

1. Remote Customer Interactive Motor Design System

Embodiments of the invention can shorten the design time and reduce the need for trial-and-error designing of electric motors through a web-based customer interactive system and method and associated manufacturing processes. Embodiments of the invention can be applied to open loop, closed loop, brush and brushless type electric motors for application in various electromechanical devices such as, but not limited to, printers, security cameras, x-y tables, scanners, CNC machines, dispensers, injector pumps, turntables, optical equipment, medical equipment, and any electromechanical motion controlled system. Particularly, embodiments of the invention find application to any field where a quick-turn design cycle is required for electric motor applications.

Embodiments of the invention can improve the process by which users of motors specify design requirements through a web utility which expedites the design cycle for wide variety of users, regardless of their level of expertise. Automated electric motor selection, design optimization, and prototyping may be integrated into the web utility to provide users with the optimum electric motor for the application requirements.

In addition, employing an embodiment of the invention, a rapid prototyping of motorized motion control systems can be made available internationally. Accuracy of electric motor design reduces the need for a trial-and-error design process.

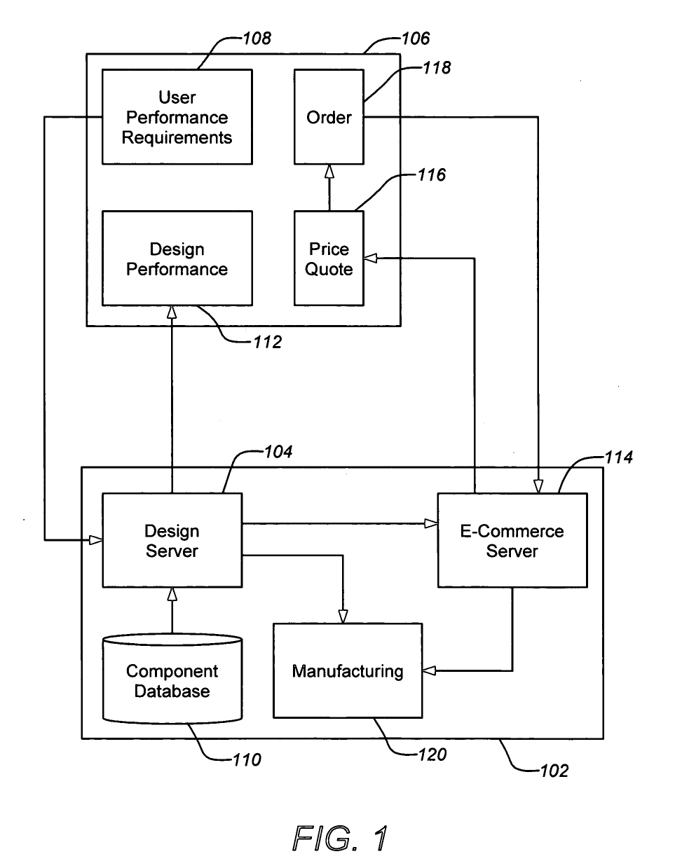

FIG. 1 depicts a functional block diagram of an exemplary embodiment of a remote customer interactive electric motor design system 100. The system 100 may comprise a business network 102 including an interconnected set of computer devices. A design server 104 (which may be a web server) is used to interact with the remote user (e.g. customer) system 106. The design server 104 receives one or more user performance requirements 108 for the desired electric motor. For example, the user may specify a desired torque, supply voltage, supply current, and/or motion profile requirements for the desired electric motor in fields provided in an interactive web page communicated from the design server 104 to a web browser of the user system 106.

The design server 104 may first perform some initial validation processing of the user performance requirements 108. For example, the user may inadvertently provide a torque, supply voltage, supply current, and/or motion profile requirements that are beyond any feasible electric motor design. In such cases, the design server 104 will identify the problem to the user and prompt the user for new performance requirements 108. Alternately, this validation processing may be programmed into the interactive web page that is running on the user system 106. The validation processing algorithm of the input user performance requirements 108 is not considered part of the design process and should not require being secured from a user's review.

As suggested above, the design algorithm which receives the input user performance requirements 108 and applies them to generate one or more electric motor designs satisfying the one or more user performance requirements 108, may be a proprietary to the design/manufacturing company. Accordingly, the algorithm may be run in isolation from the user system 106 (e.g. on the design server 104 behind network security such as a firewall). Some features of the design algorithm may include the ability to conduct a parametric search among a database 110 of existing electric motor and motor component designs to reduce the need for a unique design for each user. A parametric search is a type of search that seeks motor designs or components that include particular numeric values or attributes. Parametric searches of the present invention may be performed to identify a particular motor or component having more than one parameter of interest. In addition, as part of the design algorithm particular dimensions and/or operating parameters of motor designs may be identified as variables in mathematical relation to performance characteristics. For example, the motor windings of a stepper motor have a mathematical relationship to the motor torque. In another example, a given motor design may be employed with different operating parameters (e.g. stepping speed, voltage, amperage, etc.) to yield different performance. This principle can be further applied in evaluating the available designs in the parametric search of the database.

Each of the motor designs in the database will have a set of performance specifications that represent a single operating point. While these performance specifications may be matched to the desired performance requirements, other operating points are also possible for the same motor design. Accordingly, the performance specifications in the database may not present a full picture of a given motor design's capabilities. Thus, as part of the parametric search, the motor design algorithm may analytically determine a range of operating points (i.e. an operating curve or space) to fully evaluate the available motor designs in the database. It is the operating space (rather than the single operating point) that is compared to the requirements. The operating space may also be considered a performance estimate of the proposed design.

As an example, a user may specify customer requirements for an application utilizing a motor, e.g. load, screw pitch, efficiency, size, motion profile, etc. The customer requirements are then analyzed and converted into motor performance requirements, e.g. torque, inertia, speed, etc. One or more of the motor performance requirements correspond to searchable parameters in a database of motor designs. The motor designs in the database may specify a set of performance specifications for a particular motor design. As mentioned above, the set of performance specifications may be for a particular operating point. The design algorithm may apply the set of performance specifications of each design to yield an operating space, e.g. a torque versus speed curve, for the motor design. The operating space is then used to evaluate the acceptability of the proposed motor design. Those skilled in the art will understand many alternative analytical equations and techniques that may be applied and programmed into the design algorithm. In addition, the applied design algorithm may be proprietary. Accordingly, embodiments of the invention are not limited to any particular design algorithm.

With completion of the design algorithm and the generation of one or more complete electric motor designs, the design server 104 also provides a performance estimate 112 for each of the motor designs (e.g. calculation of performance parameters based upon the proposed design). A significant feature of embodiments of the present invention is that the system 100 provides this performance estimate 112 back to the user system 108 for evaluation by the user. This is because, although the user may provide certain performance requirements 108 for the desired motor, the actual design may In fact, it is unlikely that the design will obtain performance characteristics that exactly match the performance requirements 108. Moreover, as the performance requirements 108 are often set as performance boundaries, it is almost always preferable to have an actual design that exceeds these boundaries. In addition, it is useful for the user to have the performance estimates 112 for the proposed design so that potential motors may be compared (all of which may meet the requirements 108). Accordingly, it is especially for the customer to receive the feedback of performance characteristic estimates 112 for any proposed motor design. It is also important to note that because the user receives back the performance characteristic estimates 112 for proposed motor designs, this does not imply that the user would receive all of the actual details of the design as would be required to manufacture the proposed design (e.g. the detailed component dimensions and/or drawings, etc.). However, some design details of interest may be provided as would facilitate the evaluation of a prospective purchaser.

An optional addition to the foregoing design system 100 is to provide the ability for the user to directly place an order for one or more of the proposed electric motors. This function may be handled by an e-commerce server 114 coupled to receive the one or more complete electric motor designs from the design server 104. Similar to the user, the e-commerce server 114 may not require all the detailed design information. However, in this case the communicated information is focused on what is necessary to determine a price rather than evaluating performance. For example, a simple list of component part numbers may be all that is necessary for the e-commerce server to compile a total price for a motor design. The part numbering system may be specifically derived such that pricing/manufacturing cost may be determined. In addition, discounts may also be applied through the e-commerce server 114 (e.g. for quantity purchases, coupon codes, etc.). One or more price quotes 116 are then communicated from the e-commerce server 114 to the user system 106. The user may than generate an electronic purchase order 118 by replying directly to the price quote 116. Communication of either or both the price quote 116 and the electronic purchase order 118 may be performed separate from the design communication as shown or through the web interface of the design server 114 or through an e-mail message or any other means known in the art. An identification code may be assigned to the price quote 116 to allow the actual proposed designs to be readily recalled (e.g. if the order is placed by phone or facsimile).

Upon securing the electronic purchase order 118 (and confirming payment) the e-commerce server 114 relays the information to a manufacturing system 120 for the electric motor design to be produced. Securing the purchase order may include completing a credit card payment over the phone or online through a web service (such as through a PayPal credit card service) or e-mail or any other payment method known. The manufacturing system 120 then accessing the complete design information for the ordered electric motor from the design server in order to produce the part. The manufacturing system 120 may comprise a virtually automated prototyping system or manufacturing system or merely an computer system for component orders to be processed. In addition, the manufacturing system may reside with the design system 100 as shown or remotely.

Those skilled in the art will further appreciate that the functions of the foregoing subsystems of the design system 100 (e.g. design server 104, component database 110, e-commerce server 112, manufacturing 120) may be implemented alone or combined in different hardware and/or software without departing from the scope of the invention. For example, the design system may comprise a single physical server system programmed with software to implement the entire design server 104, component database 110 and e-commerce server 112 previously described. In another example, the pricing function may be performed as an adjunct function within the design server 104 or split between the e-commerce server 114 and the design server 104.

2. Hardware Environment

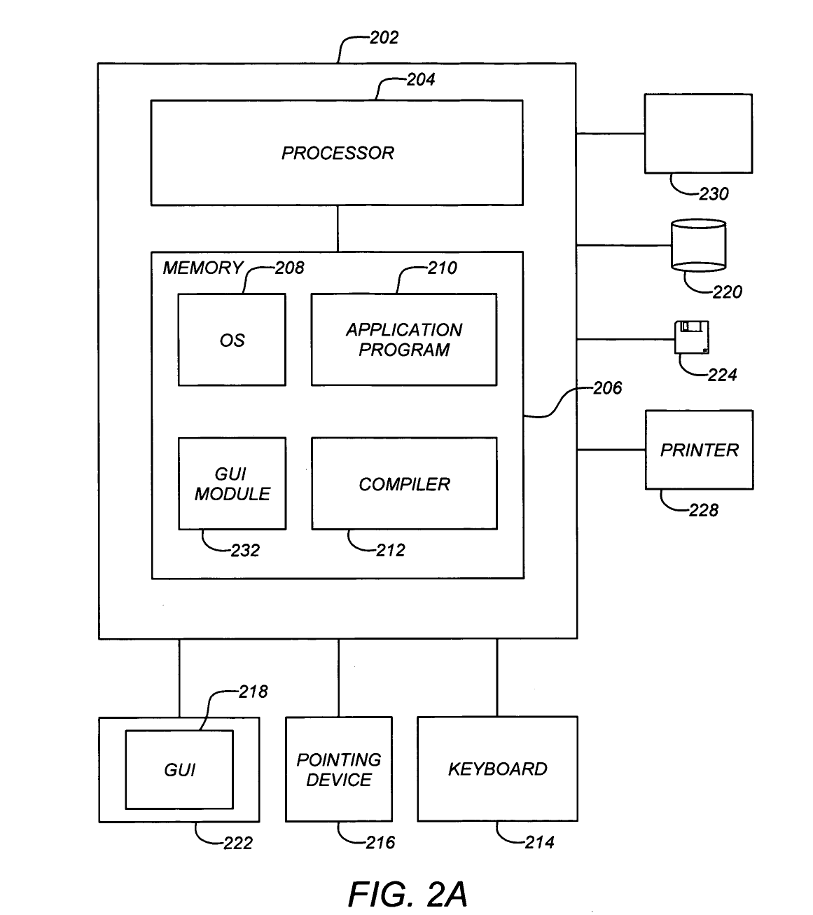

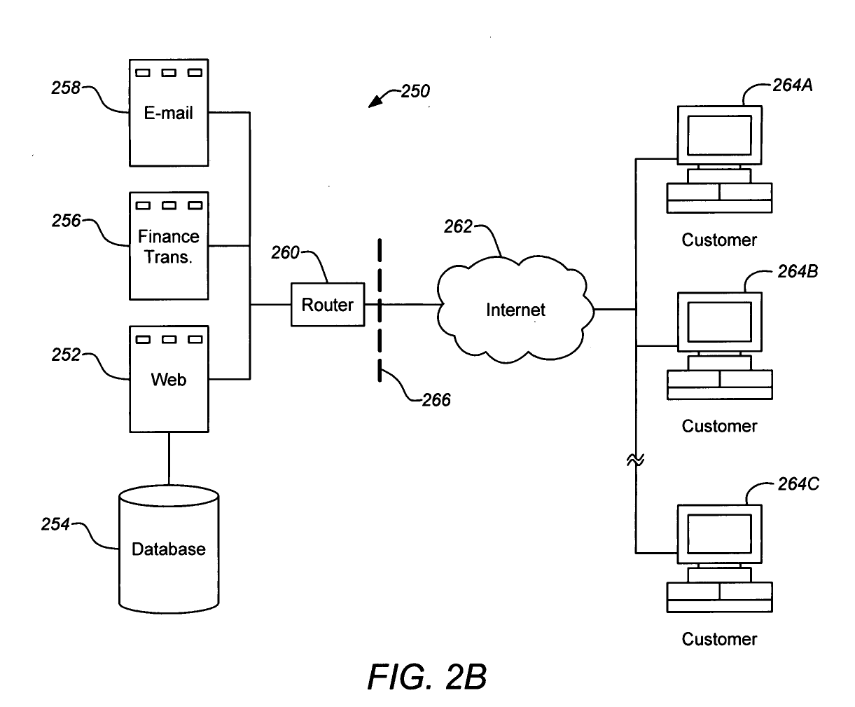

FIG. 2A illustrates an exemplary computer system 200 that can be used to implement selected modules and/or functions of the present invention. The computer 202 comprises a processor 204 and a memory 206, such as random access memory (RAM). The computer 202 is operatively coupled to a display 222, which presents images such as windows to the user on a graphical user interface 218. The computer 202 may be coupled to other devices, such as a keyboard 214, a mouse device 216, a printer, etc. Of course, those skilled in the art will recognize that any combination of the above components, or any number of different components, peripherals, and other devices, may be used with the computer 202.

Generally, the computer 202 operates under control of an operating system 208 (e.g. OS/2, LINUX, UNIX, WINDOWS, MAC OS) stored in the memory 206, and interfaces with the user to accept inputs and commands and to present results, for example through a graphical user interface (GUI) module 232. Although the GUI module 232 is depicted as a separate module, the instructions performing the GUI functions can be resident or distributed in the operating system 208, the computer program 210, or implemented with special purpose memory and processors. The computer 202 also implements a compiler 212 which allows an application program 210 written in a programming language such as C++, JAVA, ADA, BASIC, VISUAL BASIC or any other programming language to be translated into code readable by the processor 204. After being compiled, the computer program 210 accesses and manipulates data stored in the memory 206 of the computer 202 using the relationships and logic that was generated using the compiler 212. The computer 202 also optionally comprises one or more external communication devices 230 such as a modem, router, satellite link, ethernet card, or other device for communicating with other computers, e.g. via the Internet.

In one embodiment, instructions implementing the operating system 208, the computer program 210, and the compiler 212 are tangibly embodied in a computer-readable medium, e.g., data storage device 220, which could include one or more fixed or removable data storage devices, such as a zip drive, floppy disc 224, hard drive, DVD/CD-rom, digital tape, etc. Further, the operating system 208 and the computer program 210 comprise instructions which, when read and executed by the computer 202, cause the computer 202 to perform the steps necessary to implement and/or use the present invention. Computer program 210 and/or operating system 208 instructions may also be tangibly embodied in the memory 206 and/or transmitted through or accessed by the data communication device 230. As such, the terms “article of manufacture,” “program storage device” and “computer program product” as may be used herein are intended to encompass a computer program accessible and/or operable from any computer readable device or media.

FIG. 2B is a block diagram of an exemplary networked computer system 250 that can be used to perform the operations of the remote customer interactive electric motor design system. The system 250 typically comprises of one or more computer systems 200 as described in FIG. 2A. Each of the computer systems 200 employed in the system 250 may be purpose-built/programmed for a particular function within the distributed computer system 250 as is known in the art. For example, the separate computer systems 200 may be dedicated as a web server 252 (which may operate as the design server 104), a database 254 (which may operate as the component database 110) a financial transaction server 256 (which may operate as the e-commerce 114) and an e-mail server 258. Communication between the system 250 and one or more user (customer) systems 264A-264C is typically facilitated by a networking device 260 such as a router operating through the Internet 262. Security for the system 250 may be afforded through a firewall 266 which isolates the from unauthorized access or alteration. Firewall 266 functions can be applied in any manner known in the art. For example, a firewall 266 may be typically implemented within the networking device 260 that provides access to the Internet 262. Firewall 266 functions may also be employed as software within one or more of the servers/database 252-258.

Furthermore, implementation of the algorithm within the system 250 may be structured such that none of the code is displayed to the customer through the use of server side applications such as active server pages (e.g. ASP or ASP.NET), J2EE or PHP, or other web-programming technologies that allow limiting the user from access to a proprietary design algorithm.

Those skilled in the art will recognize many modifications may be made to this configurations without departing from the scope of the present invention. For example, those skilled in the art will recognize that any combination of the above components, or any number of different components, peripherals, and other devices, may be used with the present invention.

3. Web Based Remote Customer Use

As previously discussed, embodiments of the invention may be directed to methods and systems for designing and manufacturing electric motors (such as stepper motors) of custom design using a globally based information networks, such as the Internet, supporting the world wide web (www).

Information from the user such as customer contact information as well as the performance requirements for the desired electric motor is gathered from the user. In addition, it may be required that an agreement is accepted by the user that he/she will not reverse engineer the algorithm as a prerequisite to remotely accessing the electric motor design system. In any case, the programmed algorithm may be presented to the user such that the user does not have direct access to review the programmed algorithm. Thus, the programmed algorithm never leaves the secure web hosting site. All the information, particularly related to the detailed motor design is isolated from the user systems through the web-programming technologies known in the art.

As previously described, the remote design system will allow for a user to specify particular desired performance parameters and a new design will be presented to the user through the web interface. The system may also allow for the user to review performance characteristics of the proposed motor design as well as providing price. quotation to the user and direct purchase of the proposed motor design through the web interface.

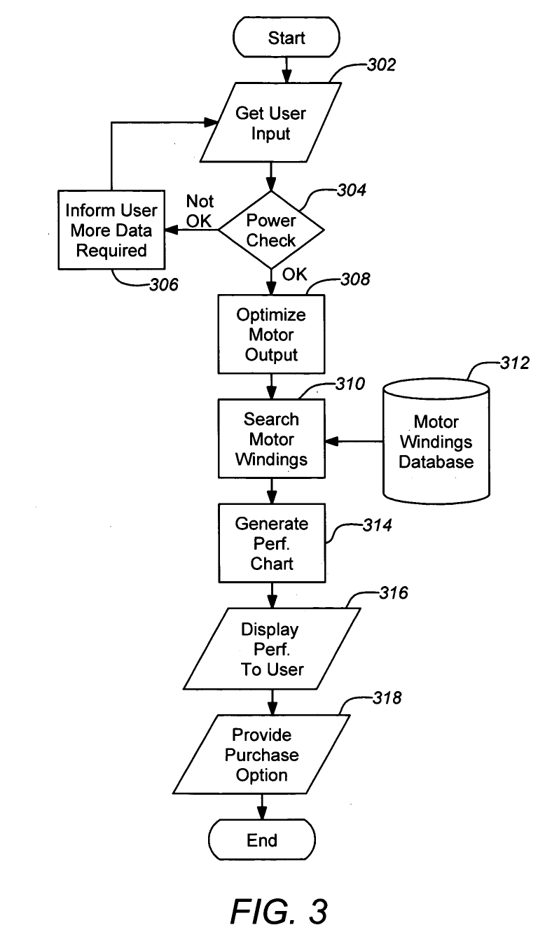

FIG. 3 is a flowchart of operations of an example remote customer interactive electric motor design process. The algorithm 300 begins with receiving the user input parameters (e.g. the desired motor performance requirements) in a block 302. The user input parameters may be related to the power in and power out and include a basic motor class selection (e.g. a motor series). For example, the power in may be provided by the user as voltage and current and the power out may be provided as speed. In another example, the power in may be provided in watts and the power out may again be provided as speed. Those skilled in the are will understand that many possible variations of the user input are possible so long as they may be analytically reduced to a power input and power output requirement parameter.

Upon receiving the user input parameters, a power check is first performed in decision block 304 to determine the feasibility that the design problem will close. For example, a quick analytical check can determine whether the input power exceeds the output power. If this is not the case, a solution is not feasible. Accordingly, the process is passed to block 306 informing the user of the situation and then returned to block 302. On the other hand, if the power check is passed, the process moves on to block 308.

In block 308 the output for the proposed motor is optimized. This may be achieved through an analytical determination of an optimal motor winding. One example of optimizing a motor design is outlined in the following section. It is important to note that embodiments of the present invention are not limited to any particular optimization algorithm.

Following optimization of the motor winding in block 308, a parametric search of a database is conducted in block 310 for existing motor winding designs having the closest match to the optimal winding determined in block 308, within a specified tolerance. The parametric search is performed over a database 312 of the existing motor winding designs. At the conclusion of the search, the estimate of the performance of the proposed motor design is calculated and displayed to the user in block 316. The performance estimate may take the form of one or more charts or graphs. The operations of blocks 308 to 316 may be performed more than once to generate alternative proposed motor designs for consideration by the user. Finally, the user is provided with an option to purchase one or more of the proposed motors at a calculated price in block 318.

4. Example Optimizing Algorithm

Algorithms for optimizing or sizing a particular electric motor (e.g. stepper motor) may vary from company to company; in some cases, a proprietary sizing algorithm may be employed that the system keeps hidden from the customer as previously described. However, in any case the core of the algorithm relies on a calculation of the optimum motor windings based on performance requirements from the customer. There are known techniques for sizing stepper motors through performing a calculation of power requirements and a verification of power input versus power output. Embodiments of the present invention encompass any stepper motor sizing algorithm that may be to programmed and applied to performance requirements of the customer.

In general, a typical programmed algorithm addresses whether there is enough power available to perform the required movement; inertia matching; torque calculation; acceleration calculations; etc. through various different applications such as, but not limited to, lead screw applications, belt and pulley applications, belt and lead screw applications, direct drive and gear driven rotary applications, ventilation cooling applications, ducted exhaust applications, motorized sliding applications, and motorized cylindrical applications. An exemplary sizing algorithm for a lead screw system proposed by a customer is provided as follows.

First, the customer provides a set of customer requirements, which include load, sizes, screw pitch, efficiency and a motion profile.

25 lb load (400 oz)
Diameter of Screw=0.25 in.
Lead Screw Length=12 in.
Pitch=3 turns per inch
Efficiency=65%
The required motion profile is to move 5 inches in 1.2 seconds
The web interface receives this input and analytically determines the necessary motor performance requirements for the customer application. This portion of the analysis involves well known engineering relationships. Accordingly, this analysis may be programmed directly into the web page delivered to the user machine from the web server. Furthermore, these equations may be presented for customer review in validating the determined motor performance requirements. In some cases, the customer may enter the web interface having already calculated the necessary motor performance requirements. The web interface may be altered as necessary to accommodate the most common performance characteristics and/or units that customers typically employ a customer requirements to specify a motor. The first part of the design algorithm converts the customer requirements provided to the appropriate motor performance requirements that will be employed in the motor design search and analysis.

$$T = \frac{F + {F}_{friction}}{2 π Pe} = \frac{400 + 40}{2 π ( 3 ) ( 0.65 )} = 36 oz \text{-} in$$

$$Js = \frac{π L ρ {r}^{4}}{2 g} = \frac{π ( 12 ) ( 4.5 ) ( {0.25}^{4} )}{2 ( 386 )} = 0.0009 oz \text{-} in \text{-} {sec}^{2}$$

$${J}_{L} = {\frac{W}{g} [ \frac{1}{2 π P} ]}^{2} = {\frac{400}{386} [ \frac{1}{2 π ( 3 )} ]}^{2} = 0.0058 oz \text{-} in \text{-} {sec}^{2}$$

$$5 in . = 15 Revs = 94 radians$$

$$A = \frac{4 ( 94 )}{{1.2}^{2}} = 261 \frac{rad}{{sec}^{2}}$$

$${V}_{Peak} = \frac{2 ( 94 )}{1.2} = 156 \frac{rad}{sec} = 4 \text{,} 970 pps$$

$${J}_{ref} = 0.0009 + 0.0058 = 0.0067 oz \text{-} in \text{-} {sec}^{2}$$

After the motor performance requirements are determined, the motor design algorithm is invoked to determine a proposed motor design that meets the performance requirements. As previously discussed, the motor design algorithm may be a proprietary design algorithm that operates under secure isolation on the web server.

In one example design algorithm, a database is consulted in a parametric search of existing or new motor designs and identify a motor meeting performance requirements of approximately 4,970 pps with approximately 50 oz-in of torque. One or more of the calculated motor performance requirements are searchable parameters within the database. In addition, as previously discussed, each of the motor designs in the database identify performance requirements that represent a single operating point, although other operating points are possible which may meet the performance requirements. Accordingly, as part of the parametric search, the motor design algorithm determines a range of operating points (i.e. an operating curve or space) to fully evaluate the performance of available motor designs in the database. The operating space comprises a performance estimate of the proposed design. The mathematical relations used to determine the operating space may be known motor analysis equations and/or proprietary equations. As previously mentioned, embodiments of the invention allow security of such proprietary equations by operating on a web server behind a firewall connection to the remote user. In this case, an existing motor design may be identified meeting the above criteria for 50 oz-in at 5000 pps. The inertia of this motor is 3.1 oz-in². Further performance estimates of the proposed design may be analytically derived as follows.
Jₘₒₜₒᵣ=0.0080 oz-in-sec²
J_{Total}=J_{ref}+Jₘₒₜₒᵣ=0.0067+0.0080=0.0147
T_{A}=J×A=0.0147×261=3.8 oz-in of torque
T_{Total}=T_{A}+T_{S}=36+3.8=39.8 oz-in
The performance estimates of the proposed design are returned to the customer for evaluation. In addition, the performance estimates may be provide in graphical form to facilitate interpretation by the customer. In this case, the performance estimate that is returned to the customer may comprise the range of operating points previously determined in evaluating the motor design.

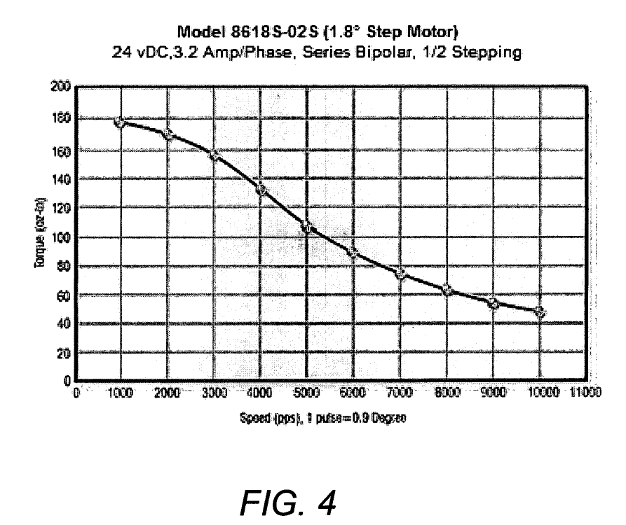

FIG. 4 illustrates an example graph 400 of a performance estimate of the proposed motor design. In this example, a torque-speed curve for a 1.8 degree series bipolar, ½ stepping, stepping motor using 24 VDC, 3.2 Amp.

Thus, the proposed motor design meets (actually exceeds) the requirements for application. A performance estimate for the proposed motor may then be plotted to demonstrate to the end user that at 24V, 3.2 Amps, the performance requirement is exceeded. In addition, more than one proposed motor design may be presented as alternatives may shown as adjustments to the first proposed motor design. Similarly, further mechanical dimensional modifications and the resulting performance changes may also be presented.

5. Exemplary Method of Remote Customer Interactive Design

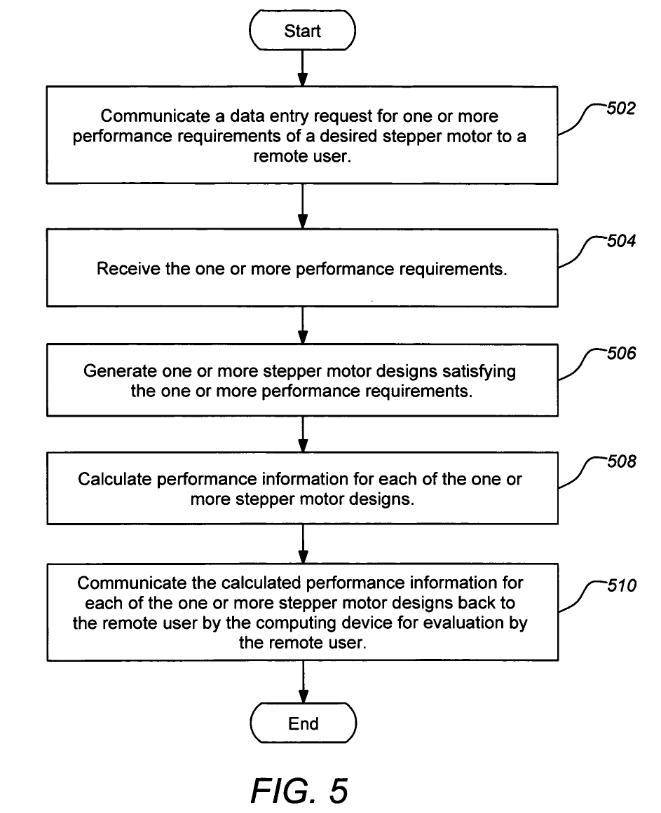

FIG. 5 is a flowchart of a typical method 500 of the present invention. The method begins with operation 502 communicating a data entry request for one or more performance requirements of a desired electric motor to a remote user. Next, in operation 504 the one or more performance requirements are received. Following this, in operation 506 one or more electric motor designs are generated satisfying the one or more performance requirements. In operation 508 performance information is calculated for each of the one or more electric motor designs. Finally, in operation 510 the calculated performance information for each of the one or more electric motor designs is communicated back to the remote user by the computing device for evaluation by the remote user. The method may be further modified consistent with the system embodiments previously described.

The method 500 may further include an optional operation of performing a power calculation based on the one or more performance requirements from the remote user to check for power availability before generating the one or more electric motor designs.

If the data entry request comprises one or more interactive web pages from an Internet-connected computer network device and the Internet-connected computer network device comprises a web server coupled to a database server, the method 500 may further include an operation of preparing the one or more interactive web pages with the web server. In addition, the method 500 may include operations where the one or more performance requirements are received with the web server, and the one or more existing component models are provided to the database server for selection by an electric motor design algorithm in a parametric search to be employed in the one or more electric motor designs.

Also, the method 500 may include operations of receiving the one or more electric motor designs from the web server with an e-commerce server and generating a price quote for the one or more electric motor designs with the e-commerce server. The method 500 may further comprise operations of receiving an electronic purchase order with the e-commerce server in response to the user accepting the price quote and sending a confirmation e-mail message of the electronic purchase order with the e-mail server.

This concludes the description including the preferred embodiments of the present invention. The foregoing description including the preferred embodiment of the invention has been presented for the purposes of illustration and description. It is not intended to be exhaustive or to limit the invention to the precise form disclosed. Many modifications and variations are possible in light of the above teaching.

What is claimed is:

1. A system for electric motor design, comprising:
a communication device for communicating a data entry request for one or more performance requirements of a desired electric motor to a remote user; and
a computing device for receiving the one or more performance requirements and generating one or more electric motor designs satisfying the one or more performance requirements;
wherein calculated performance information for each of the one or more electric motor designs are communicated back to the remote user by the computing device for evaluation by the remote user.

2. The system of claim 1, wherein the computing device performs a power calculation based on the one or more performance requirements from the remote user to check for power availability.

3. The system of claim 1, wherein the one or more performance requirements comprise a torque, a resistance, motor voltage, motor current, a supply voltage, a supply current, and a motion profile.

4. The system of claim 1, wherein the communication device comprises an Internet-connected computer network device and the data entry request comprises one or more interactive web pages.

5. The system of claim 4, wherein the Internet-connected computer network device comprises a web server coupled to a database server, the web server for preparing the one or more interactive web pages and receiving the one or more performance requirements and the database server for providing one or more existing component models available for selection by an electric motor design algorithm in a parametric search to be employed in the one or more stepper motor designs.

6. The system of claim 5, wherein the one or more existing component models comprise one or more electric motor winding designs.

7. The system of claim 5, wherein the electric motor design algorithm comprises a secure design algorithm blocked from review by the remote user.

8. The system of claim 5, further comprising an e-commerce server coupled to the web server, the e-commerce server for receiving the one or more electric motor designs and generating a price quote for the one or more electric motor designs.

9. The system of claim 8, further comprising an e-mail server coupled to the e-commerce server, where an electronic purchase order is received by the e-commerce server in response to the user accepting the price quote and the e-mail server to sends a confirmation e-mail message of the electronic purchase order.

10. The system of claim 8, wherein the price quote comprises an identification code for the user to place an order by facsimile or telephone.

11. A method for designing an electric motor, comprising:
communicating a data entry request for one or more performance requirements of a desired electric motor to a remote user;
receiving the one or more performance requirements;
generating one or more electric motor designs satisfying the one or more performance requirements;
calculating performance information for each of the one or more electric motor designs; and
communicating the calculated performance information for each of the one or more electric motor designs back to the remote user by the computing device for evaluation by the remote user.

12. The method of claim 11, further comprising performing a power calculation based on the one or more performance requirements from the remote user to check for power availability before generating the one or more electric motor designs.

13. The method of claim 11, wherein the one or more performance requirements comprise a torque, a resistance, motor voltage, motor current, a supply voltage, a supply current, and a motion profile.

14. The method of claim 11, wherein the data entry request comprises one or more interactive web pages from an Internet-connected computer network device.

15. The method of claim 14, wherein the Internet-connected computer network device comprises a web server coupled to a database server and further comprising:
preparing the one or more interactive web pages with the web server;
receiving the one or more performance requirements with the web server; and
providing one or more existing component models with the database server for selection by an electric motor design algorithm in a parametric search to be employed in the one or more electric motor designs.

16. The method of claim 15, wherein the one or more existing component models comprise one or more electric motor winding designs.

17. The method of claim 15, wherein the electric motor design algorithm comprises a secure design algorithm blocked from review by the remote user.

18. The method of claim 15, further comprising receiving the one or more electric motor designs from the web server with an e-commerce server; and
generating a price quote for the one or more electric motor designs with the e-commerce server.

19. The method of claim 18, further comprising receiving an electronic purchase order with the e-commerce server in response to the user accepting the price quote; and
sending a confirmation e-mail message of the electronic purchase order with the e-mail server.

20. The method of claim 18, wherein the price quote comprises an identification code for the user to place an order by facsimile or telephone.
